(19) United States
(12) Patent Application Publication
(10) Pub. No.: US 2023/0118426 A1
(43) Pub. Date: Apr. 20, 2023

(54) TIRE FOR A MOTOR VEHICLE

(71) Applicant: Continental Reifen Deutschland GmbH, Hannover (DE)

(72) Inventor: Ahmet Özüduru, Hannover (DE)

(73) Assignee: Continental Reifen Deutschland GmbH, Hannover (DE)

(21) Appl. No.: 17/759,354

(22) PCT Filed: Nov. 30, 2020
(86) PCT No.: PCT/EP2020/083829

§ 371 Date: Jul. 22, 2022

(30) Foreign Application Priority Data
Jan. 24, 2020 (DE) 10 2020 200 845.0

(51) Int. Cl. B60C 13/00

(52) U.S. Cl. CPC B60C 13/001

(57) ABSTRACT

The present invention relates to a tire (1) for a motor vehicle, in particular a tire (1) having a first indicator (2) for indicating a tire size and having a second indicator (3) with a letter for indicating a load rating of the tire (1). According to the invention, the first indicator (2) and the second indicator (3) are arranged adjacently on the tire (1). Here, the first indicator (2) may be arranged above, below or next to the second indicator (3). A separator (4) may be arranged between the two indicators.

The present invention relates to a tire for a motor vehicle, in particular a tire having a first indicator for indicating a tire size and having a second indicator with a letter for indicating a load rating of the tire.

In the case of tires for motor vehicles, a distinction is made between the three tire classes C1 for passenger cars, C2 for light commercial vehicles and C3 for heavy commercial vehicles. In the case of tires of category C2, the operating code load range X, often also abbreviated to LR X, is located on the sidewall of the tire for markets such as the USA. Here, the X stands as a placeholder for one of the load ranges or load ratings. With this identifier and the identifier for the tire size, a tire categorization is carried out, and this is taken into account, inter alia, during tire storage.

The tire size is indicated on the sidewall of the tire by a standardized sequence of numbers and letters. This sequence indicates the tire width, the ratio of the height to the width of the tire, the designation of the design, the rim diameter, the designation of the tire load capacity, also referred to as the load capacity index or load index, and the maximum permissible speed, also referred to as the speed index.

The load range and the load capacity index are different items of information. While the load capacity index is expressed by numbers, which can be between 19 and 204, the load range is expressed by a letter, which can range from B to F.

In practice, it has been found that errors occur repeatedly in determining the data for the tire size and load range identifier on the sidewall of the tire by scanning systems or human beings. Moreover, it often takes a relatively long time for the data to be determined. Both lead to delays in categorization.

A problem addressed by the invention is that of providing a tire for a motor vehicle, in the case of which the determination of the data for the tire size and load range identifier on the sidewall of the tire is facilitated.

This object is achieved by a tire for a motor vehicle with the features of claim 1. The dependent claims relate to preferred configurations of the invention.

According to the invention, in the case of a tire for a motor vehicle, which has a first indicator for indicating a tire size and a second indicator with a letter for indicating a load rating of the tire, the first indicator and the second indicator are arranged adjacently on the tire.

Since there is no requirement for the positioning of the tire size and the load range on the tire, these are often indicated far apart on the sidewall. This makes it difficult for both human beings and automatic scanning systems to find these indicators. In the solution according to the invention, these details are arranged adjacently on the tire, thus enabling them to be found quickly. They are located close together in a small reading field of view or in a small area to be detected by a scanning system. As a result, less time is required to carry out correct categorization.

According to one aspect of the invention, the first indicator has a letter for indicating a tire class. This is the case, in particular, with tires that have a C identifier. Tires with a C identifier are used mainly on commercial vehicles, but also on vans, off-road vehicles and in some cases on SUVs. They are standardized in accordance with Regulation No 54 of the United Nations Economic Commission for Europe (ECE R 54). Here, the letter C stands for Commercial or Cargo and is an indication of the reinforced structure of the carcass. For European C2 and C3 tires, the letter ‘C’ must appear in the tire size after the rim dimension.

According to one aspect of the invention, the first indicator and the second indicator are arranged one above the other in the radial direction of the tire. This arrangement has the advantage that both indicators can be arranged within a relatively small area, which can be detected rapidly by a scanning system or a human being. Owing to the limited space on the sidewall of the tire in the radial direction, it may be necessary here to use a smaller font size for the indicators than is usually the case.

According to one aspect of the invention, the first indicator and the second indicator are arranged next to one another in the circumferential direction of the tire. In this arrangement, the space available on the sidewall of the tire in the radial direction can be used in the normal way, i.e. it is not necessary to use a smaller font size. On the other hand, however, indicators that are arranged next to one another extend over a larger area in the circumferential direction. It is therefore expedient to select the font size or font in such a way that both indicators can nevertheless be detected quickly.

According to one aspect of the invention, a separator is arranged between the first indicator and the second indicator. Such a separator, for example a simple dash or slash, makes it easier to distinguish between the two indicators during data acquisition by a scanning system or by a human being.

According to one aspect of the invention, the tire is of tire class C2. Specifically in the case of European C2 tires, on which the letter C must appear in the tire size after the rim dimension, confusion very often occurs. This C is mistakenly taken for the load range identifier by scanning systems or human beings. It is therefore expedient, at least in the case of such tires, to implement the solution according to the invention in order to avoid such confusion.

Of course, the solution according to the invention can also be used on other tires where confusion can occur due to certain characters or sequences of characters in the indicators.

Further features of the present invention will become apparent from the following description and the appended claims in conjunction with the figures.

### OVERVIEW OF THE FIGURES

FIG. 1 shows schematically a tire according to the prior art for a motor vehicle;

FIG. 2 shows a detail of the sidewall of the tire from FIG. 1 with an indicator for the tire size;

FIG. 3 shows a detail of the sidewall of the tire from FIG. 1 with an indicator for the load range;

FIG. 4 shows schematically a first embodiment of a tire according to the invention for a motor vehicle;

FIG. 5 shows a detail of the sidewall of the tire of FIG. 4 with indicators arranged one above the other;

FIG. 6 shows schematically a second embodiment of a tire according to the invention for a motor vehicle; and

FIG. 7 shows a detail of the sidewall of the tire from

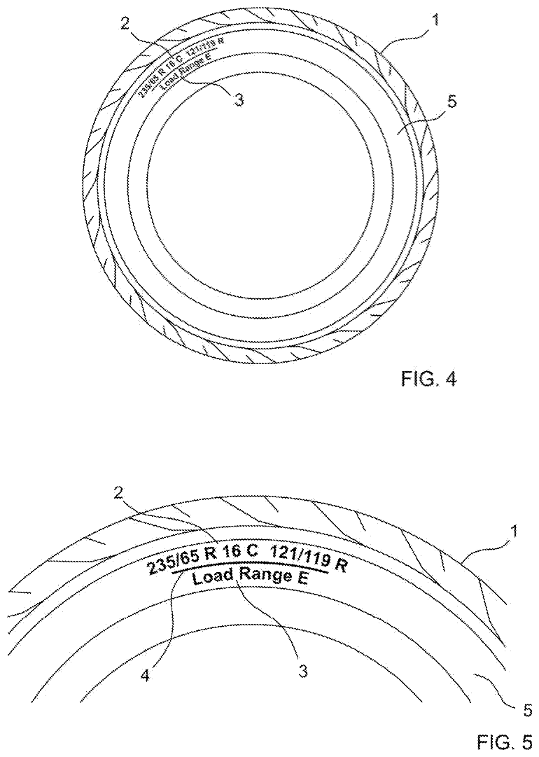

FIG. 4 with indicators arranged next to one another.

### DESCRIPTION OF THE FIGURES

For a better understanding of the principles of the present invention, embodiments of the invention will be explained in more detail below with reference to the figures. The same reference signs will be used in the figures for identical or functionally identical elements and are not necessarily described again for each figure. It is to be understood that the invention is not restricted to the illustrated embodiments and that the features described can also be combined or modified without departing from the scope of protection of the invention as defined in the appended claims.

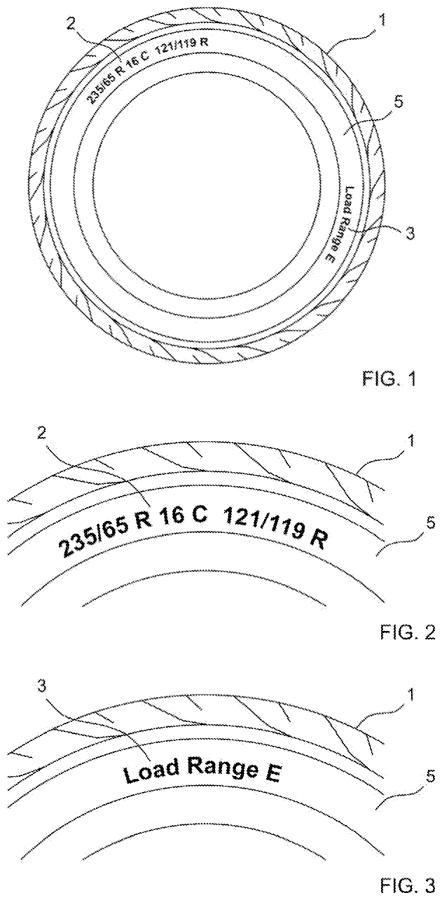

FIG. 1 shows schematically a tire 1 according to the prior art for a motor vehicle. The tire has two indicators 2, 3 on its sidewall 5. A first indicator 2 indicates the tire size by means of a standardized sequence of numbers and letters. The second indicator 3 indicates the load range. Since there is no requirement for the positioning of the tire size and the load range on the tire 1, these are often positioned far apart on the sidewall 5. This makes it difficult for both human beings and automatic scanning systems to find these indicators 2, 3. For greater clarity, FIG. 1 does not show further indicators which can usually be found on tires 1.

FIG. 2 shows a detail of the sidewall 5 of the tire 1 from FIG. 1 with the indicator 2 for the tire size. In the example illustrated, the tire size is 235/65 R 16 C 121/119 R. The individual components of the sequence of numbers and letters are the tire width (235 mm), the ratio of the height to the width of the tire (65%), the designation of the design (R for radial tires), the rim diameter (16 inches), the C designation, the designation of the tire load capacity (121 for individual tires≙1450 kg; 119 for twin tires≙1360 kg) and the permissible maximum speed (R≙170 km/h).

FIG. 3 shows a detail of the sidewall 5 of the tire 1 from FIG. 1 with the indicator 3 for the load range. In the example illustrated, it is the load range E. The possible load ranges range from B to F. Specifically in the case of European C2 tires, on which the letter C must appear in the tire size after the rim dimension, confusion very often occurs. This C is mistakenly taken for the load range identifier by scanning systems or human beings.

FIG. 4 shows schematically a first embodiment of a tire 1 according to the invention for a motor vehicle. In this embodiment, the two indicators 2, 3 for the tire size and the load range identifier are arranged one above the other in the radial direction of the tire 1. A detail of the sidewall 5 of the tire 1 with the indicators 2, 3 arranged one above the other is shown in FIG. 5. This arrangement has the advantage that both indicators 2, 3 can be arranged within a relatively small area, which can be detected rapidly by a scanning system or a human being. Owing to the limited space on the sidewall 5 of the tire 1 in the radial direction, the indicators 2, 3 in the example illustrated have a smaller font size than is usually the case. It is, of course, also possible to use different font sizes for the two indicators 2, 3. The indicators 2, 3 can be separated from one another by a separator 4, for example a simple line, which makes it easier to distinguish between the two indicators 2, 3 during data acquisition by a scanning system or by a human being. In the example illustrated, the indicator 2 for the tire size is arranged above the indicator 3 for the load range identifier. Of course, the arrangement can also be precisely the reverse.

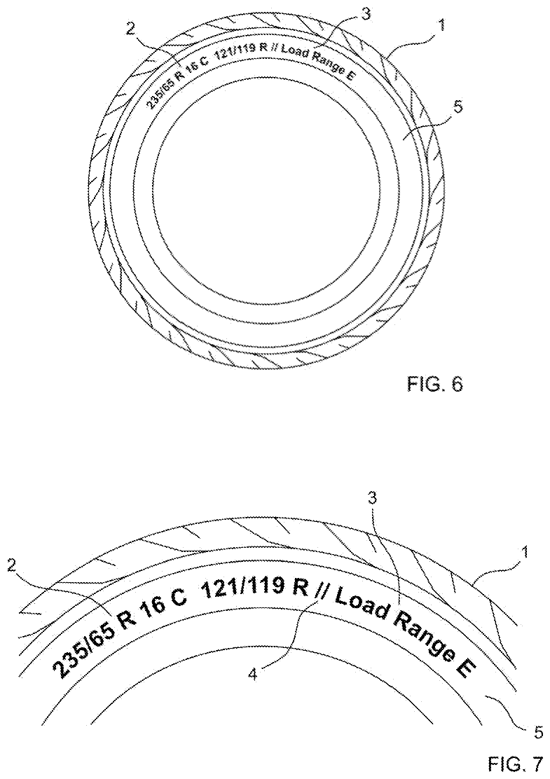

FIG. 6 shows schematically a second embodiment of a tire 1 according to the invention for a motor vehicle. In this embodiment, the two indicators 2, 3 for the tire size and the load range identifier are arranged next to one another in the circumferential direction of the tire 1. A detail of the sidewall 5 of the tire 1 with the indicators 2, 3 arranged next to one another is shown in FIG. 7. This arrangement has the advantage that the space available on the sidewall 5 of the tire 1 in the radial direction can be used in the normal way. It is not necessary to use a smaller font size for the indicators 2, 3. For this purpose, the indicators 2, 3 arranged next to one another extend over a relatively large area in the circumferential direction. In this embodiment too, the indicators 2, 3 can be separated from one another by a separator 4, e.g. a slash or, as shown in FIG. 7, a double slash, which makes it easier to distinguish between the two indicators 2, 3 during data acquisition by a scanning system or by a human being. In the example illustrated, the indicator 2 for the tire size is arranged to the left of the indicator 3 for the load range identifier. Of course, the arrangement can also be precisely the reverse.

### LIST OF REFERENCE SIGNS

1 Tire
2 First indicator
3 Second indicator
4 Separator
5 Sidewall

1.-6. (canceled)

7. A tire for a vehicle, the tire comprising:
a first indicator formed on a sidewall to indicate a tire size and a tire class;
a second indicator adjacent the first indicator to indicate a load rating; and
a scanning system configured to categorize the tire based on the first indicator and the second indicator.

8. The tire of claim 7, the first indicator further comprises a letter for indicating a tire class.

9. The tire of claim 7, the first indicator and the second indicator positioned one above the other in a radial direction of the tire.

10. The tire of claim 7, the first indicator and the second indicator arranged next to one another in a circumferential direction of the tire.

11. The tire of claim 7, further comprising a separator arranged between the first indicator and the second indicator.

12. The tire of claim 11, the tire class indicating tire class C2.

13. The tire of claim 7, the separator comprising a line.

14. The tire of claim 7, the separator comprising a plurality of angled slashes.

15. The tire of claim 7, the first indicator further comprising tire width, ratio, design designation, and max speed.

16. The tire of claim 7, the scanning system configured to categorize the tire for storage.
